(19) United States
(12) Patent Application Publication
(10) Pub. No.: US 2015/0234117 A1
(43) Pub. Date: Aug. 20, 2015

(54) LIGHT-SOURCE DEVICE AND DISPLAY DEVICE PROVIDED WITH SAME

(71) Applicant: SHARP KABUSHIKI KAISHA, Osaka (JP)

(72) Inventor: Kentaro Kamada, Osaka (JP)

(73) Assignee: Sharp Kabushiki Kaisha, Osaka (JP)

(21) Appl. No.: 14/428,930

(22) PCT Filed: Sep. 13, 2013
(86) PCT No.: PCT/JP2013/074820

§ 371 Date: Mar. 17, 2015

(30) Foreign Application Priority Data
Sep. 19, 2012 (JP) 2012-205705

(51) Int. Cl. F21V 8/00

(52) U.S. Cl. CPC G02B 6/0091; G02B 6/0085

(57) ABSTRACT

A light source device is equipped with a light source, a light guide plate into which enters light emitted by the light source through end faces of the light guide plate, and clearance adjustment parts for adjusting the clearance between the light source and the light guide plate.

### TECHNICAL FIELD

The present invention relates to a light source device, and more particularly to a light source device that is provided with a light guide plate and emits light in a planar manner. The present invention also relates to a display device provided with such a light source device.

### BACKGROUND ART

A liquid crystal display device is known as an example of a display device that display images. Liquid crystal display devices are provided with a liquid crystal panel and a light source device (referred to as a backlight device) that illuminates the liquid crystal panel from behind. These light source devices include types known as direct-lit and edge-lit (side-lit) devices.

As disclosed in Patent Document 1, for example, an edge-lit type light source device is provided with a light source and a light guide plate arranged so that light from the light source enters from the end (side) of the light guide plate. According to Snell's law, among the light that has emerged from the light source and entered the light guide plate, light having an angle component greater than the critical angle repeatedly undergoes total reflection inside the light guide plate, and light having an angle component smaller than the critical angle is emitted outside the light guide plate. Light scattering elements that cause light to scatter (scattering dots, unevenness, etc.) are formed on one of the two mutually facing principal surfaces of the light guide plate. As a result, light undergoing total reflection inside the light guide plate can be extracted to the outside of the light guide plate, and emitted in a planar manner.

Patent document 1 discloses a technique for positioning and fixing the light guide plate to a frame that forms a portion of the light source device, so that the light guide plate does not become displaced with respect to the frame.

### RELATED ART DOCUMENT

### Patent Document

Patent Document 1: Japanese Patent Application Laid-Open Publication No. 2002-42535

### SUMMARY OF THE INVENTION

### Problems to be Solved by the Invention

Variation is present in the dimensions of the components constituting a light source device (dimensional variation), and variation (assembly variation) also arises during assembly of a light source device. These variations can cause deterioration in the display quality of a display device in which the light source device is incorporated. Examples of deterioration in display quality are described below.

FIG. 11 is a plan view that schematically shows a conventional light source device 100 when viewed from above. The conventional light source device 100 is an edge-lit type light source device, and is configured such that the light sources 102 are arranged opposite two end faces 101a and 101b that are parallel in the lengthwise direction of the light guide plate 101. A plurality of individual light sources 102 (e.g., light-emitting diodes) is arranged on the substrate 103 in this configuration, and the substrate 103 is mounted on a heat spreader 104. The heat spreader 104 is secured to a chassis (not shown) that forms a portion of the light source device 100.

As a result of the dimensional variation and/or assembly variation described above, differences can arise between the clearance CL1 between the light source 102 and the first end face 101a and the clearance CL2 between the light source 102 and the second end face 101b in the conventional light source device 100, as shown in FIG. 11. In FIG. 11, clearance CL2 is larger than clearance CL1.

In this kind of light source device 100, an imbalance in brightness (luminance) can arise, as shown in FIG. 11. In the example shown in FIG. 11, the lower half of the light guide plate 100 is darker than the upper half. In particular, there is a large difference in brightness between the region near the first end face 101a and the region near the second end face 101b. Consequently, display quality will become non-uniform in a liquid crystal display device incorporating as a backlight the light source device 100 having such imbalance in brightness.

When using the technique disclosed in Patent Document 1, it is possible to suppress the occurrence of variation in clearance between the light guide plate and light sources caused by assembly variation. However, if component dimensional variation has occurred, for example, there is a concern that the non-uniform display quality described above could easily occur when using this technique.

In consideration of the situation described above, an objective of the present invention is to provide a light source device that readily suppresses the occurrence of uneven brightness resulting from component dimensional variation and assembly variation. A further objective of the present invention is to provide a display device that readily suppresses deterioration in display quality through the provision of such a light source device.

### Means for Solving the Problems

To achieve the aforementioned objectives, a light source device of the present invention has a configuration includes: a light source a light source; a light guide plate having an end face into which light emitted from the light source enters; and a clearance adjustment part for adjusting clearance between the light source and the light guide plate (configuration 1).

According to this configuration, clearance between the light source and the light guide plate can be easily set to a prescribed value (design value) because clearance adjustment parts are provided. In other words, according to this configuration, it is possible to provide a light source device that readily suppresses the occurrence of uneven brightness resulting from component dimensional variation and assembly variation.

In the light source device according to configuration 1, it is preferable that the clearance adjustment part comprise: a protruding member that projects from part of a first member forming a portion of the light source device; and a contact surface that is included on a second member forming a portion of the light source device and that contacts the protruding member (configuration 2). According to this configuration, the clearance adjustment parts can be obtained without increasing the number of new members; this is beneficial in terms of cost.

The light source device of configuration 2 may further include a substrate on which the light source is mounted; and a heat dissipation member to which the substrate is attached, wherein the protruding member is formed on the end face of the light guide plate, and wherein the contact surface is included on one of the substrate and the heat dissipation member (configuration 3).

It is preferable that the light source device according to configuration 3 further include a securing member to which the heat dissipation member is secured by a fastener, that an engaging hole that engages with the fastener be formed in the securing member, that a through-hole into which the fastener is inserted is formed in the heat dissipation member, and that the through-hole is larger than the engaging hole (configuration 4). A screw can be cited as an example of the fastener. According to this configuration, clearance between a light source and a light guide plate can be adjusted to a design value by screw-fastening a heat dissipation member (to which is attached a substrate on which is mounted a light source) to a chassis (securing member) of a light source device.

The light source device according to configuration 2 may be further provided with a substrate on which the light source is mounted, wherein the protruding member is formed on the end face of the light guide plate, and wherein the contact surface is included on the substrate (configuration 5). The light source device according to the present configuration is also useful in that the heat dissipating member may be shared with external components of a device (liquid crystal display device, etc.) incorporating a light source device, for example.

The light source device of any of configurations 1 to 5 may be configured such that the light source is provided on each of two end faces of the light guide plate that oppose each other (configuration 6). In a light source device in which the light sources are arranged opposite each of the two mutually facing end faces of the light guide plate, component dimensional variation and assembly variation can cause imbalance in brightness over a region bounded by the center of the light guide plate, for example. However, the present configuration can reduce the possibility of such a condition (imbalance in brightness) arising, because the present configuration is provided with clearance adjustment parts.

To achieve the above-described objectives, a display device according to the present invention is configured so as to include the light source device according to any of configurations 1 to 6; and a display panel illuminated with light by the light source device (configuration 7). The display device according to the present configuration is configured so as to be provided with a light source device that readily suppresses the occurrence of uneven brightness due to component dimensional variation and assembly variation, and can therefore readily suppress deterioration in display quality.

In the display device according to the seventh configuration, a configuration in which the display panel is a liquid crystal panel (configuration 8) may be adopted.

### Effects of the Invention

By means of the present invention it is possible to provide a light source device that readily suppresses the occurrence of uneven brightness resulting from component dimensional variation and assembly variation. Also, by means of the present invention it is possible to provide a display device that readily suppresses deterioration in display quality by being provided with such a light source device.

### BRIEF DESCRIPTION OF THE DRAWINGS

FIG. 1 is a top view that schematically shows a light source device according to Embodiment 1 of the present invention.

FIG. 2 is a cross-sectional view that schematically shows the light source device of FIG. 1 along the line A-A.

FIG. 3 is a plan view that schematically shows Modification Example 1 of the light source device according to Embodiment 1.

FIG. 4 is a plan view that schematically shows Modification Example 2 of the light source device according to Embodiment 1.

FIG. 5 is a plan view that schematically shows Modification Example 3 of the light source device according to Embodiment 1.

FIG. 6 is a top view that schematically shows a light source device according to Embodiment 2 of the present invention.

FIG. 7 is a cross-sectional view that schematically shows the light source device of FIG. 6 along the line B-B.

FIG. 8 is a top view that schematically shows a light source device according to Embodiment 3 of the present invention.

FIG. 9 is a top view that schematically illustrates a configuration of a liquid crystal display device according to an embodiment of the present invention.

FIG. 10 is a cross-sectional view that schematically shows the light source device of FIG. 9 along the line C-C.

FIG. 11 is a plan view that schematically shows a conventional light source device viewed from above.

### DETAILED DESCRIPTION OF EMBODIMENTS

Embodiments of the light source device and display device of the present invention are described below with reference to the drawings.

### Embodiment 1

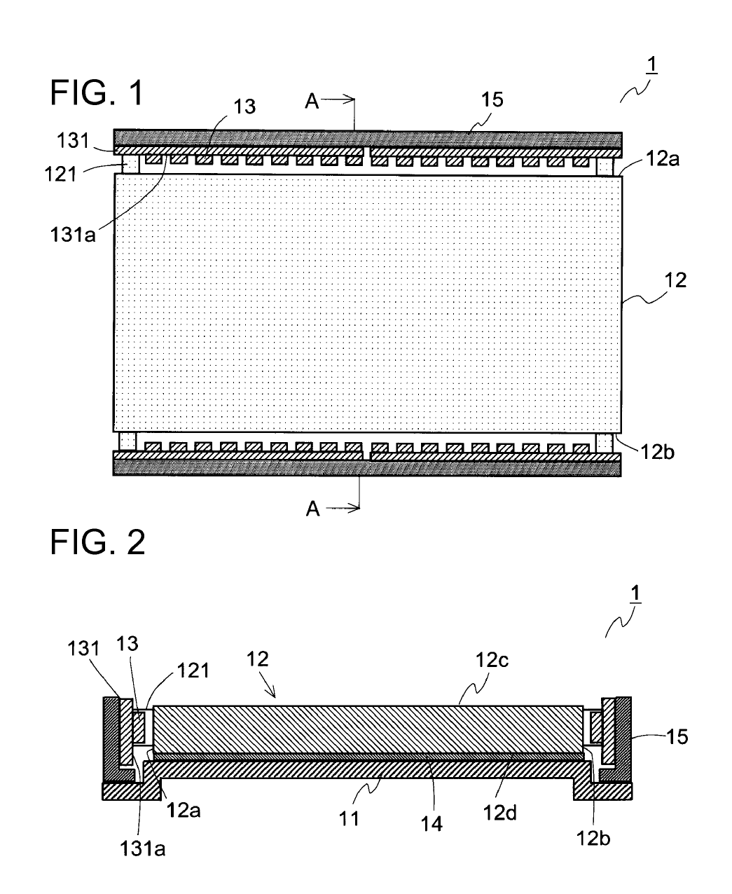

FIG. 1 is a top view that schematically shows a light source device 1 according to Embodiment 1 of the present invention. FIG. 2 is a cross-sectional view that schematically shows the light source device of FIG. 1 along the line A-A. As shown in FIG. 1 and FIG. 2, the light source device 1 is provided with a chassis 11 that can be obtained by processing sheet metal, for example. A light guide plate 12, a light source 13, a reflective sheet 14 and a heat spreader 15 are mounted on the chassis 11.

The light guide plate 12 is a substantially rectangular, flat member in top view, and is formed from a resin such as polymethyl methacrylate (PMMA), for example. The light sources 13 are arranged respectively opposite two end faces 12a and 12b (mutually facing end faces 12a, 12b) that are parallel in a lengthwise direction of the light guide plate 12. Protruding members 121 that project in a direction substantially perpendicular to the two end faces 12a and 12b are provided at both lengthwise ends of the two end faces 12a and 12b. The protruding members 121 provided on the two end faces 12a and 12b are arranged symmetrically with a principal surface of the light guide plate 12 interposed therebetween. The protruding members 121 may be separate members to the light guide plate 12, but it is preferable that the protruding members 121 be molded integral to the light guide plate 12. Also, a shape of the protruding members 121 has no particular limitations, and can be cylindrical, prismatic or the like, for example. Further, it is preferable that the protruding members 121 be members that readily transmit light.

As the light source 13, an LED (Light Emitting Diode) is suitable, but other light emitting elements may be used. The light sources are 13 are mounted on a substrate 131 and are arranged in rows in parallel to a lengthwise direction of the end faces 12a and 12b of the light guide plate 12. The substrate 131 is secured to a heat spreader 15. As the substrate 131, a known printed substrate can be used, and this may be a flexible substrate such as an FPC (Flexible Printed Circuit), or a rigid substrate, for example. In this embodiment, the number of substrates 131 arranged opposite the end faces 12a and 12b is more than one (two in this embodiment), but the number of substrates may be changed to one depending on circumstances.

Light emitted by the light sources 13 enters the light guide plate 12 from the end faces 12a and 12b of the light guide plate 12. Among the light that has entered the light guide plate 12, light having an angle component equal to or greater than a critical angle propagates inside the light guide plate 12 while undergoing total refection. Light scattering elements (not shown) are formed on either one of two mutually facing principal surfaces 12c and 12d of the light guide plate 12. By means of these light scattering elements, it is possible to uniformly extract from the principal surface 12c (upper principal surface in FIG. 2) light that has repeatedly undergone total reflection inside the light guide plate 12. As the light scattering elements, scattering dots obtained by the printing of ink with a refractive index greater than that of a material forming the light guide plate 12 can be used, for example. Also, formation of minute unevenness, lens shapes, or the like, on a principal surface can be cited as alternative examples of the light scattering elements.

A reflective sheet 14 is arranged opposite the principal surface 12d (lower principal surface in FIG. 2) situated opposite the principal surface 12c that serves as a light-exiting surface of the light guide plate 12. The reflective sheet 14 has a role of reflecting and thereby returning into the light guide plate 12 light emitted outside of the light guide plate 12 (principal surface 12d). By providing the reflective sheet 14 it is possible to increase the efficiency of light utilization. By providing the chassis 11 with the function of a reflective surface, a configuration without the reflective sheet 14 may be adopted.

The heat spreader 15 is formed by a member with high heat dissipation (heat dissipation member) and has the role of dissipating heat emitted from the light sources 13. The heat spreader 15 is affixed to the chassis 11. The heat spreader 15 may be shared with external components of a liquid crystal display device incorporating the light source device 1, for example.

In addition, an optical sheet that regulates light emitted from the light guide plate 12 may be arranged on a light-exiting surface 12c of the light guide plate 12 in the light source device 1. As the optical sheet, a scattering sheet, prism sheet or the like can be used, for example, and the number and type of optical sheets may be appropriately set. One or a plurality of optical sheets (of the same or different types) may be used.

An example procedure for assembling the above-described light source device 1 is described below. First, the light guide plate 12 is secured in position on the chassis 11 using a positioning part (not shown). At this stage, the reflective sheet 14 is secured in position therewith. Also, before and after, or at the same time as, attaching the light guide plate 12 to the chassis 11, the substrate 131 on which a plurality of light sources 13 are mounted is affixed to the heat spreader 15 using a double-sided adhesive or the like, for example.

Next, the heat spreader 15 with the affixed substrate 131 is affixed to the chassis 11 after being positionally adjusted, while the protruding members 121 of the light guide plate 12 are pressed against a contact surface 131a (placement surface on which the light sources 13 are placed) of the substrate 131. The heat spreader 15 can be affixed to the chassis 11 using an adhesive agent, adhesive tape or the like, for example. As a result, the light source device 1 is obtained.

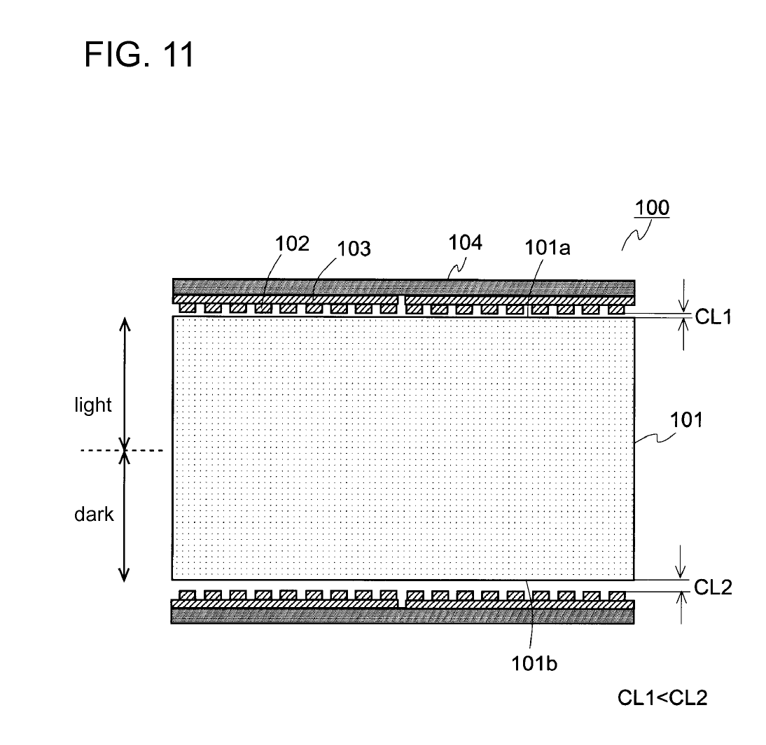

In the light source device 1 of the present embodiment, a clearance can be set between the light sources 13 and light guide plate 12 (end faces 12a and 12b of the light guide plate 12) by means of the protruding members 121 pressed against the contact surface 131a. For this reason, the clearance between the light sources 13 and light guide plate 12 at a first end face 12a side and second end face 12b side can be easily made uniform. For this reason, the above-described imbalance in brightness (see FIG. 11) is unlikely to occur in the light source device 1.

In the light source device 1, clearance adjustment parts of the present invention are constituted by the protruding members 121 provided on the light guide plate 12, and the contact surface 131a of the substrate 131. For example, when a design value for clearance between the light sources 13 and light guide plate 12 is 1.3 mm, supposing a thickness of the light source 13 (LED) is 0.9 mm, then a height of the protruding members 121 will be 2.1 mm (=1.3 mm+0.9 mm).

If dimensional variation has occurred between each protruding member 121 (four in this embodiment), variation will arise in the above-described clearance. However, if dimensions of the protruding members 121 have been strictly controlled, for example, it is possible to curtail the possibility of the light source device 1 being deemed defective due to the above-described clearance being unsuitable after assembly. In this regard too, the light source device 1 of the present embodiment can be considered to be a configuration that readily suppresses the occurrence of uneven brightness resulting from component dimensional variation and assembly variation.

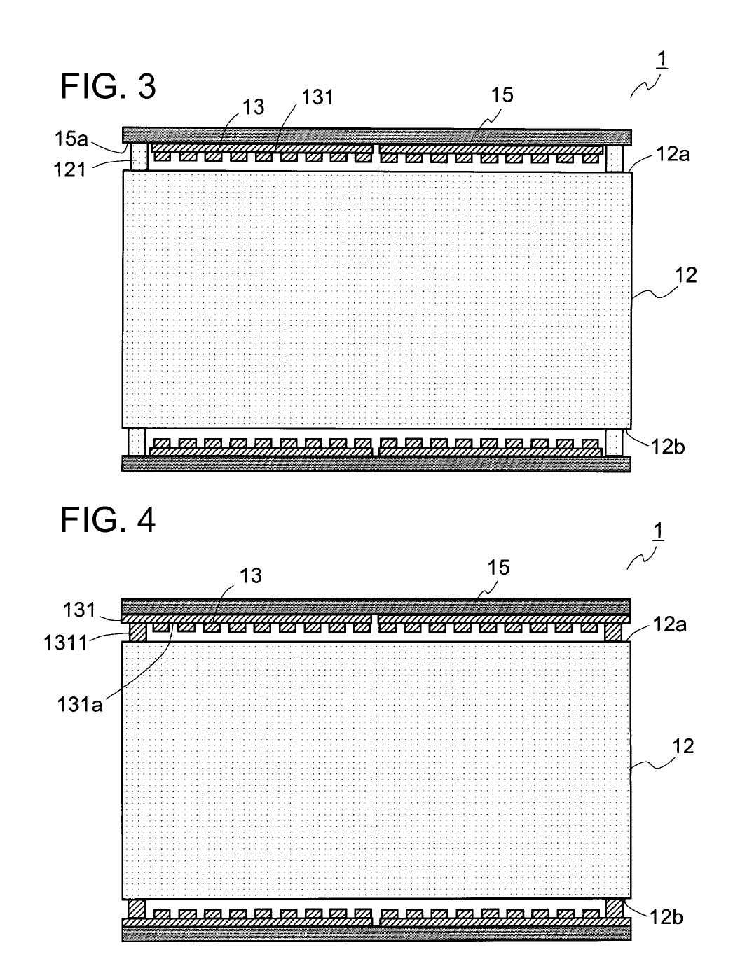

In the above description, the clearance adjustment parts are constituted by the protruding members 121 provided on the light guide plate 12, and the contact surface 131a of the substrate 131. However, this is only one example. FIG. 3 is a plan view that schematically shows Modification Example 1 of the light source device 1 according to Embodiment 1. As shown in FIG. 3, clearance adjustment parts may be constituted by protruding members 121 provided on a light guide plate 12, and a contact surface 15a of a heat spreader 15. The contact surface 15a of the heat spreader 15 corresponds to a surface to which substrate 131 is affixed.

FIG. 4 is a plan view that schematically shows Modification Example 2 of the light source device according to Embodiment 1. As shown in FIG. 4, clearance adjustment parts may be constituted by protruding members 1311 provided on a substrate 131, and end faces 12a and 12b (contact surfaces) of a light guide plate 12. The protruding members 1311 provided on the substrate 131 project in a direction substantially perpendicular to a placement surface on which light sources 13 of the substrate 131 are placed.

FIG. 5 is a plan view that schematically shows Modification Example 3 of the light source device according to Embodiment 1. As shown in FIG. 5, clearance adjustment parts may be constituted by protruding members 151 provided on a heat spreader 15, and end faces 12a and 12b (contact surfaces) of a light guide plate 12. The protruding members 151 provided on the heat spreader 15 project in a direction substantially perpendicular to a surface of the heat spreader 15 to which the substrate 131 is affixed.

### Embodiment 2

Next, a schematic configuration of a light source device according to Embodiment 2 of the present invention will be described. The description of the light source device of Embodiment 2 will omit features shared in Embodiment 1 and will focus on the differences from Embodiment 1. Also, components shared with Embodiment 1 will be described using the same reference characters.

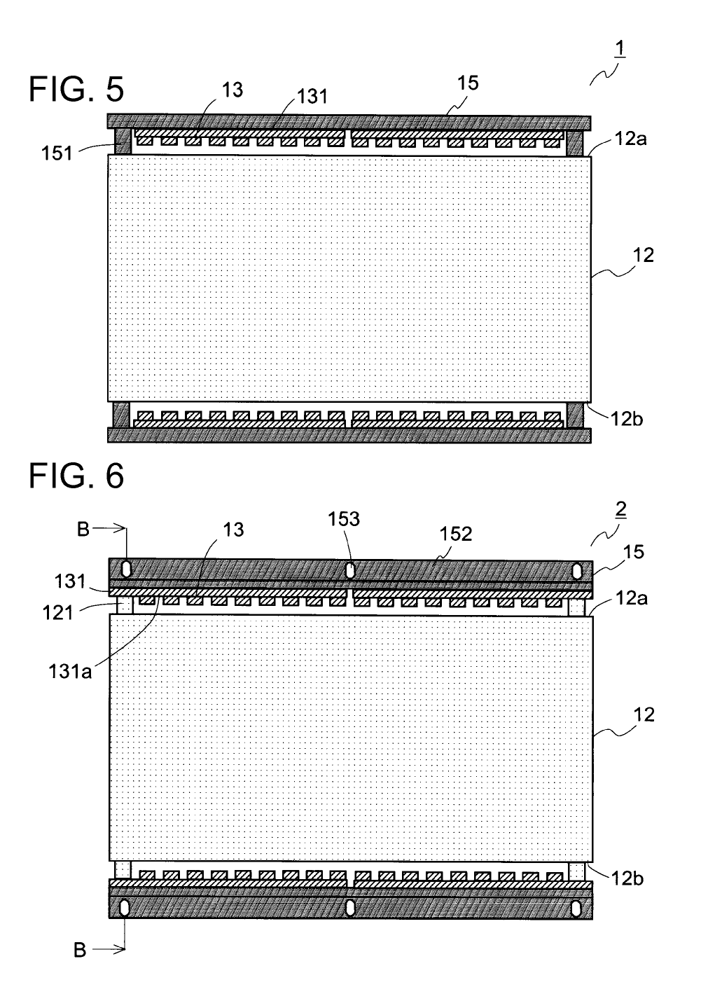

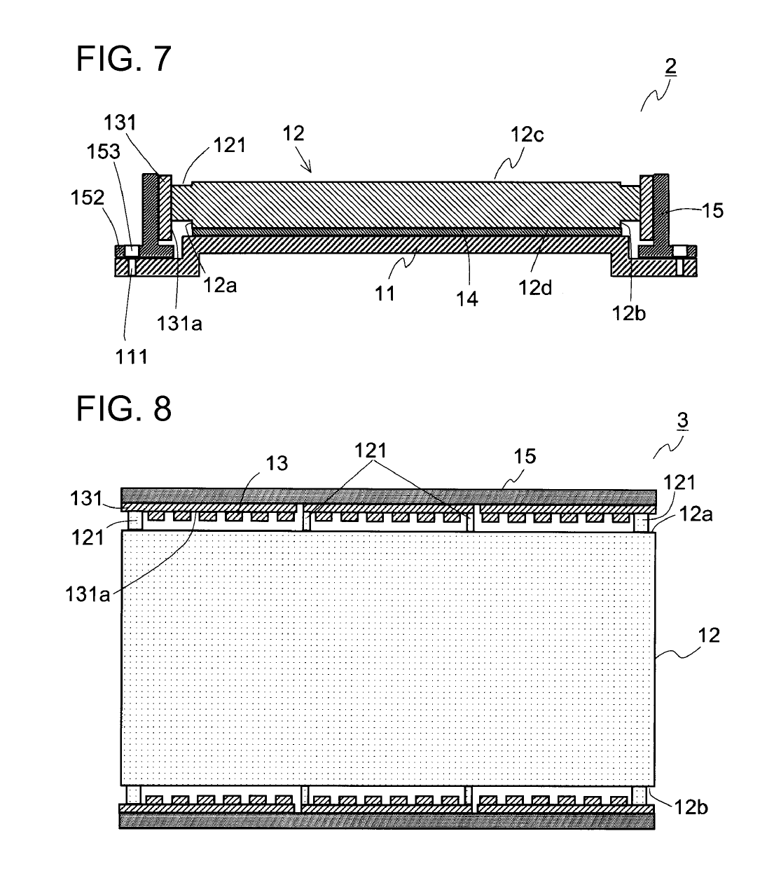

FIG. 6 is a top view that schematically shows a light source device 2 according to Embodiment 2 of the present invention. FIG. 7 is a cross-sectional view that schematically shows the light source device 2 in FIG. 6 along the line B-B. In the light source device 2 of Embodiment 2, a structure for attaching a heat spreader 15 to a chassis 11 differs from that of the light source device 1 of Embodiment 1. In the light source device 2 of Embodiment 2, the heat spreader 15 is screwed to the chassis 11. FIG. 6 and FIG. 7 omit reference to a screw for securing the heat spreader 15 to the chassis 11.

The heat spreader 15 requires a screwing region 152 in order to be screwed to the chassis 11. For this reason, the heat spreader 15 differs from that of Embodiment 1 (substantially L-shaped in cross-section; see FIG. 2) in being substantially T-shaped in cross-section (see FIG. 7). The screwing region 152 is provided with three through-holes 153 to accommodate screws. These through-holes 153 are elongated holes that extend in a direction at right angles to a lengthwise direction of the heat spreader 15. The present embodiment is configured such that the through-holes 153 are provided at three places, namely at the center and both ends along a length of the heat spreader 15, but the places where the through-holes are provided may be suitably changed from the configuration of the present embodiment.

As shown in FIG. 7, the chassis 11 is provided with screw holes 111 for screw-fastening the heat spreader 15 mounted on the chassis 11. The screw holes 111 are provided at three places corresponding to the through-holes 153 provided in the heat spreader 15. The heat spreader 15 is secured to the chassis 11 by adjusting the position of the heat spreader 15 (with a substrate 131 attached) mounted on the chassis 11, inserting screws into the screw holes 111 while these screws are inserted in the through-holes 153, and tightening the screws.

Here, when securing the heat spreader 15 to the chassis 11, the position of the heat spreader 15 is adjusted while placing protruding members 121 of a light guide plate 12 against a contact surface 131a of the substrate 131, so that clearance between a light source 13 and the light guide plate 12 attains a prescribed value. The assembly method requires room for adjustment of the position of the heat spreader 15 relative to the chassis 11 in a direction parallel to a direction of protrusion of the protruding members 12. For this reason, the through-holes 153 are described as elongated holes. The through-holes 153 should at least be of a length greater than the screw holes 111 along the direction of protrusion of the protruding members 121, and may be so-called unloaded holes or the like, for example.

A screw is an example of a fastener of the present invention; as a fastener, a rivet or the like may be used, for example, instead of a screw. Also, the screw hole 111 is an example of an engaging hole of the present invention, and the through-hole 153 is an example of a through-hole of the present invention. Further, the chassis 11 is an example of a securing member of the present invention.

In addition, the screw-fastening method for the heat spreader 15 adopted in the light source device 2 of Embodiment 2 may be used in the configurations of the first to third variations of Embodiment 1.

### Embodiment 3

Next, a schematic configuration of the light source device according to Embodiment 3 of the present invention will be described. The description of the light source device of Embodiment 3 will omit those features shared with Embodiment 1 and will focus on the differences from Embodiment 1. Also, components shared with Embodiment 1 will be described using the same reference characters.

FIG. 8 is a top view that schematically shows a light source device 3 according to Embodiment 3 of the present invention. In the light source device 3 of Embodiment 3, the number of substrates 131 arranged along each end face 12a and 12b of a light guide plate 12 is greater than in the configuration of Embodiment 1. Also, in the light source device 3 of Embodiment 3, the number of protruding members 121 provided on each end face 12a and 12b of the light guide plate 12 is greater than in the configuration of Embodiment 1. Specifically, the protruding members 121 provided on the two end faces 12a and 12b of the light guide plate 12 are provided not only at both lengthwise ends but also at two places towards a center.

By providing protruding members 121 towards the center, improvement can be expected in the precision of the prescribed value of clearance between a light source 13 and the light guide plate 12. In particular, the application of this configuration may be beneficial if a light-exiting surface of the light source device is enlarged. It is preferable that the protruding members 121 provided towards the center in particular be of a size (of course, this excludes the size in the direction of protrusion) that is as small as possible. By doing so, the generation of parts with decreased luminance (dark spots) due to providing the protruding members 121 is readily suppressed.

A configuration providing protruding members other than at both of the ends parallel to a lengthwise direction of the light guide plate 12 may be applied to configurations of first to third variations of Embodiment 1 and/or the configuration of Embodiment 2.

### Embodiment 4

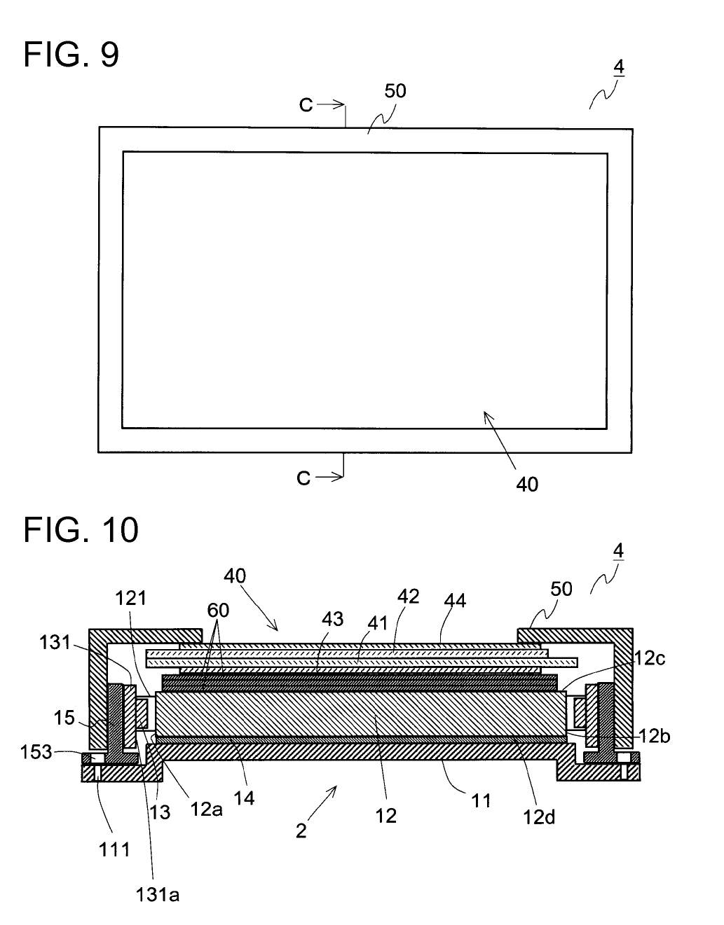

Next, a configuration of a liquid crystal display device according to an embodiment of the present invention will be described. FIG. 9 is a top view that schematically illustrates a configuration of a liquid crystal display device 4 according to an embodiment of the present invention. FIG. 10 is a cross-sectional view along the line C-C in FIG. 9 that schematically shows a liquid crystal display device 4. As shown in FIG. 9 and FIG. 10, the liquid crystal display device 4 is provided with a liquid crystal panel 40 and a light source device 2 (the light source device of Embodiment 2). The liquid crystal panel 40 and the light source device 2 are integrated by means of a frame-shaped bezel 50 that engages with a chassis 11.

In the description herein, the light source device 2 of Embodiment 2 is applied to the liquid crystal display device 4, but light source devices 1 and 3 of Embodiment 1 (including variations) and Embodiment 3 can similarly be applied to the liquid crystal display device.

In the liquid crystal panel 40, liquid crystal (not shown) is enclosed between a pair of glass substrates 41 and 42 facing each other with a gap therebetween. Also, the liquid crystal panel 40 includes polarizing plates 43 and 44 attached to each outer surface of the pair of glass substrates 41 and 42.

A plurality of switching elements, such as TFTs (Thin Film Transistors), and pixel electrodes connected to these switching elements are arranged in matrix form on the surface of a first glass substrate 41. Also, a plurality of scan signal lines and data signal lines (neither shown) that drive the plurality of switching elements are formed in a mutually intersecting manner on the first glass substrate 41. An opposite electrode and color filters (neither shown) are formed on a second glass substrate 42.

The light source device 2 functions as a backlight device that radiates light from a back surface of the liquid crystal panel 40. Light that has emerged from a light-exiting surface 12c after entering a light guide plate 12 by emission from a light source 13 passes through a plurality of optical sheets 60 arranged between the light guide plate 12 and liquid crystal panel 40 and then reaches the liquid crystal panel 40. The plurality of optical sheets 60 includes a diffusion sheet and a prism sheet, for example. In this embodiment the number of optical sheets 60 is three, but this number may be changed as appropriate.

Any of the light source devices 1 to 3 according to the above-described embodiments can be applied to the liquid crystal display device 4. As described above, light source devices 1 to 3 include clearance adjustment parts constituted by protruding members 121 and a contact surface 131a. For this reason, imbalance of brightness of light emerging from light source devices 1 to 3 is unlikely to occur. Furthermore, non-uniformity of display quality is unlikely to occur in the liquid crystal display device 4 that includes this kind of light source device 1 to 3.

<Other>

The embodiments presented above are only illustrative examples of the present invention. In other words, the scope of the present invention includes suitable variations of the above-described embodiments insofar as the scope of technical ideas of the present invention is not departed from.

The above-described embodiments are configured such that light sources 13 are respectively arranged opposite two mutually facing end faces 12a and 12b of the light guide plate 12. However, this does not mean that the scope of the present invention is limited to this configuration. In other words, the present invention can also be applied to a configuration in which light sources 13 are arranged at only one side of two mutually facing end faces 12a and 12b of a light guide plate 12.

Also, the present invention can be applied to cases where a light source 13 is constituted by a cold-cathode tube, or cases where, for example, a light guide plate 12 is wedge-shaped or the like, rather than flat.

Also, in the embodiments presented above, the light source device according to the present invention was configured to be applied to a liquid crystal display device. However, the scope of application of the light source device of the present invention is not limited to a liquid crystal display device. In other words, the light source device of the present invention is also naturally applicable to a display device constituted by a display panel that uses an electro-optical material other than liquid crystal as an optical switching material.

### DESCRIPTION OF REFERENCE CHARACTERS

1, 2, 3 light source device
4 liquid crystal display device
11 chassis (securing member)
12 light guide plate
12a, 12b end face of light guide plate
13 light source
15 heat spreader (heat dissipating member)
40 liquid crystal panel
111 screw hole (engaging hole)
121, 1311, 151 protruding member (part of clearance adjustment part)
131 substrate
131a contact surface (part of clearance adjustment part)
153 through-hole

1. A light source device, comprising:
a light source;
a light guide plate having an end face into which light emitted from said light source enters; and
a clearance adjustment part for adjusting clearance between said light source and said light guide plate.

2. The light source device according to claim 1, wherein said clearance adjustment part comprises:
a protruding member that projects from a portion of one of the light source and the light guide plate towards another of the light source and the light guide plate, the protruding member contacting a surface of a portion of said another of the light source and the light guide plate.

3. The light source device according to claim 2,
wherein the light source includes a substrate on which a light emitting element is mounted and a heat dissipation member to which said substrate is attached,
wherein said protruding member is formed on said end face of said light guide plate, and
wherein said surface with which the protruding member makes contact is on one of said substrate and said heat dissipation member.

4. The light source device according to claim 3, further comprising:
a securing member to which said heat dissipation member is secured by a fastener,
wherein an engaging hole that engages with said fastener is formed in said securing member,
wherein a through-hole into which said fastener is inserted is formed in said heat dissipation member, and
wherein said through-hole is larger than said engaging hole.

5. The light source device according to claim 2,
wherein the light source includes a substrate on which a light emitting element is mounted,
wherein said protruding member is formed on said end face of said light guide plate, and
wherein said surface with which the protruding member makes contact is on said substrate.

6. The light source device according to claim 1, wherein said light source is provided on each of two end faces of said light guide plate that oppose each other.

7. A display device, comprising:
the light source device according to claim 1; and
a display panel illuminated with light by said light source device.

8. The display device according to claim 7, wherein said display panel is a liquid crystal panel.
